(19) United States
(12) Patent Application Publication
(10) Pub. No.: US 2020/0019044 A1
(43) Pub. Date: Jan. 16, 2020

(54) CAMERA APPARATUS

(71) Applicant: Felix J.E. Comeau, Toronto (CA)

(72) Inventor: Felix J.E. Comeau, Toronto (CA)

(21) Appl. No.: 16/510,473

(22) Filed: Jul. 12, 2019

Related U.S. Application Data
(60) Provisional application No. 62/696,889, filed on Jul. 12, 2018.

(51) Int. Cl. G03B 17/56; B60R 11/04; B60R 25/04; B60R 11/00; F16M 13/02

(52) U.S. Cl. CPC G03B 17/561; B60R 11/04; B60R 25/04; B60R 2011/0056; F16M 13/022; B60R 2011/0026; B60R 11/00

(57) ABSTRACT

Apparatus for use with a vehicle having a seat for a driver and a windshield. The apparatus includes a camera and a suction cup attached to the camera having a central hollow. A light is contained in the hollow. The suction cup, the light and the camera are adapted such that, in use, the suction cup is secured to the windshield, the camera is orientated to capture a view of the driver of the vehicle and the light, when illuminated, is visible through the windshield.

### CROSS-REFERENCE TO RELATED APPLICATION

This application claims the benefit of U.S. Provisional Patent Application Ser. No. 62/696,889 filed Jul. 12, 2018.

### BACKGROUND OF THE INVENTION

### 1. Field of the Invention

The invention relates to the field of breath alcohol ignition interlocks.

### 2. Prior Art

It is well known to secure a motor vehicle against operation by a person that has consumed alcohol by installing in said vehicle a breath alcohol tester. A typical arrangement, known as a breath alcohol ignition interlock device, involves a relay interposed in the electrical circuit that feeds the starter motor, the relay being controlled by the breath tester such that the vehicle cannot be started until a satisfactory breath sample has been given. Persons that have been convicted of impaired driving are often required to have a device of this type installed in any vehicle that they wish to drive as a condition of licensure.

For a variety of reasons, it is not uncommon that a camera, which takes a picture of the driver during the delivery of a breath sample, be included as part of the licensure requirements.

### SUMMARY OF THE INVENTION

Forming one aspect of the invention is apparatus for use with a vehicle having a seat for a driver and a windshield, the apparatus comprising: a camera; a suction cup attached to the camera and having a central hollow; and a light contained in the hollow, the suction cup, the light and the camera being adapted such that, in use, the suction cup is secured to the windshield, the camera is orientated to capture a view of the driver of the vehicle and the light, when illuminated, is visible through the windshield.

Further advantages, features and characteristics of the invention will become apparent upon a review of the following detailed description and the appended drawings, the latter being briefly described hereinafter.

### BRIEF DESCRIPTION OF THE DRAWINGS

FIG. 1 is a front top right view of apparatus according to an exemplary embodiment of the invention;

FIG. 2 is a front top right view of the apparatus of FIG. 1;

FIG. 3 is a rear view of the apparatus of FIG. 1;

FIG. 4 is a right side view of the apparatus of FIG. 1;

FIG. 5 is a top view of the apparatus of FIG. 1;

FIG. 6 is a left side view of the apparatus of FIG. 1;

FIG. 7 is a bottom view of the apparatus of FIG. 1; and

FIG. 8 is a front view of the apparatus of FIG. 1.

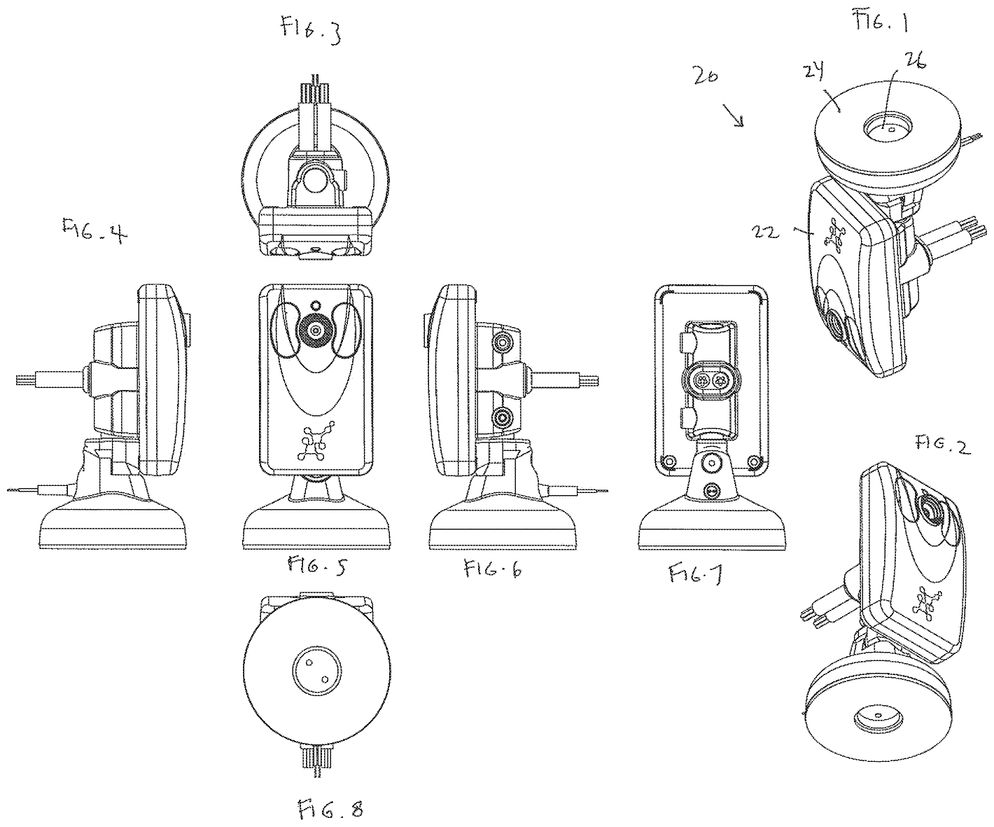

### DETAILED DESCRIPTION OF THE EXEMPLARY EMBODIMENT

Reference is made to the figures which show the aforementioned exemplary embodiment 20 of the invention which will be seen to include a camera 22, a suction cup 24 and a light 26. The camera is a digital camera suitable for taking relatively high quality images in low light conditions. The suction cup is attached to the camera and has a central hollow. The light is contained in the hollow and is a high intensity LED. The apparatus is advantageously used with a vehicle having a seat for a driver and a windshield and in combination with a breath alcohol ignition interlock device.

In use:
the suction cup is secured to the windshield;
the camera is coupled to and triggerable by the breath alcohol ignition interlock device and orientated to capture a view of the driver of the vehicle when so triggered;
the light is coupled to and triggerable by the breath alcohol ignition interlock when the device is in an alarm state (such as when the operator has failed to give a breath test when prompted) and adapted, when triggered, to be readily visible to other drivers and nearby pedestrians, through the windshield.

Whereas a specific embodiment is herein shown and described, variations are possible. Accordingly, the invention should be understood to be limited only by the accompanying claims, purposively construed.

What is claimed is:

1. Apparatus for use with a vehicle having a seat for a driver and a windshield, the apparatus comprising:
a camera;
a suction cup attached to the camera and having a central hollow; and
a light contained in the hollow,
the suction cup, the light and the camera being adapted such that, in use, the suction cup is secured to the windshield, the camera is orientated to capture a view of the driver of the vehicle and the light, when illuminated, is visible through the windshield.
